(19) United States
(12) Patent Application Publication
(10) Pub. No.: US 2025/0364153 A1
(43) Pub. Date: Nov. 27, 2025

(54) TERMINAL

(71) Applicant: Manaflex, LLC, Waikoloa, HI (US)

(72) Inventors: Robert C. LANE, Las Vegas, NV (US); Augusto E. BARTON, Pinecrest, FL (US); Yifei LIU, Toronto (CA)

(21) Appl. No.: 19/213,121

(22) Filed: May 20, 2025

Related U.S. Application Data
(60) Provisional application No. 63/650,371, filed on May 21, 2024.

(51) Int. Cl. H01B 5/00

(52) U.S. Cl. CPC H01B 5/002

(57) ABSTRACT

A process involves building up a terminal by starting with a thin, long material and then manipulating it to thicken up portions of a circuit where needed. In various implementations, the material can be rolled and squashed, or folded up to form the thickened portions of a circuit. Once it is squashed or folded up, the layers can be welded together. This process allow the initial printing of a thin conductor, which can then be thickened later in one of several ways.

### CROSS-REFERENCE TO RELATED APPLICATION

This patent application is a non-provisional application of, and claims priority to and the benefit of, U.S. Provisional Patent Application No. 63/650,371, filed May 21, 2024, the entire disclosure of which is incorporated by reference in its entirety.

### TECHNICAL FIELD

This disclosure relates to the technical field of a terminal.

### SUMMARY

The purpose of the techniques disclosed herein is to provide a terminal to overcome deficiencies in the prior art.

In one aspect of the present disclosure, a terminal comprises a conductor including a first conductor section having a first conductor portion, a second conductor portion, a third conductor portion, a first fold line located between the first conductor portion and the second conductor portion, the first fold line including a first plurality of cutouts, and a second fold line located between the second conductor portion and the third conductor portion, the second fold line including a second plurality of cutouts.

In one embodiment, the conductor further comprises a second conductor section having a fourth conductor portion, a fifth conductor portion, a sixth conductor portion, a third fold line located between the fourth conductor portion and the fifth conductor portion, the third fold line including a third plurality of cutouts, and a fourth fold line located between the fifth conductor portion and the sixth conductor portion, the fourth fold line including a fourth plurality of cutouts.

In another embodiment, the conductor includes a first plurality of fuses located between the first conductor section and the second conductor section.

In an alternative embodiment, the conductor includes a second plurality of fuses located between the first conductor section and a positive terminal.

In yet another embodiment, the conductor includes a third plurality of fuses located between the second conductor section and a negative terminal.

In another aspect of the present disclosure, a terminal comprises a conductor including a first conductor portion, a second conductor portion, a third conductor portion, a first fuse being coupled to the first conductor portion and the second conductor portion, a second fuse being coupled to the second conductor portion and the third conductor portion, a first spark arresting material being located between the first conductor portion and the second conductor portion, and a second spark arresting material being located between the second conductor portion and the third conductor portion, wherein the conductor is in a folded configuration.

In one embodiment, the conductor is in a stacked configuration.

In another embodiment, the conductor is in a rolled configuration.

### DESCRIPTION OF THE DRAWINGS

In order to more clearly illustrate the technical solutions in the embodiments disclosed herein, the drawings are briefly introduced below. Obviously, the drawings described below are only some embodiments disclosed herein. For ordinary technicians in this field, other drawings can be obtained based on these drawings without creative work.

FIG. 1 is a plan view of an embodiment of a terminal in an unfolded configuration according to the present invention.

FIG. 2 is an end view of an embodiment of a terminal in an unfolded configuration.

FIG. 3 is a side view of an embodiment of a terminal in a folded configuration.

FIG. 4 is a side view of another embodiment of a terminal in a folded configuration.

FIG. 5 is a side view of another embodiment of a terminal in a folded configuration.

FIG. 6 is a side view of another embodiment of a terminal in a folded configuration.

### DETAILED DESCRIPTION

In one embodiment, the process involves building up a terminal by starting with a thin, long material and then manipulating it to thicken up portions of a circuit where needed. In various implementations, the material can be rolled and squashed, or folded up to form the thickened portions of a circuit. Once it is squashed or folded up, the layers can be welded together. This process allow the initial printing of a thin conductor, which can then be thickened later in one of several ways.

To aid in the folding, some perforations or cut outs can be provided in a line in the material to be folded to force the fold at these lines.

In addition, fuses are included in series and parallel along the flattened portion. The fuses can be strategically placed as they are folded or rolled such that they can positioned away from other fuses to ensure clearing.

In one embodiment, a spark arresting material can be placed in between the layers so that fuses that clear can interact with a high temperature dielectric that can draw energy from the arc in the form of phase change or sensible heat.

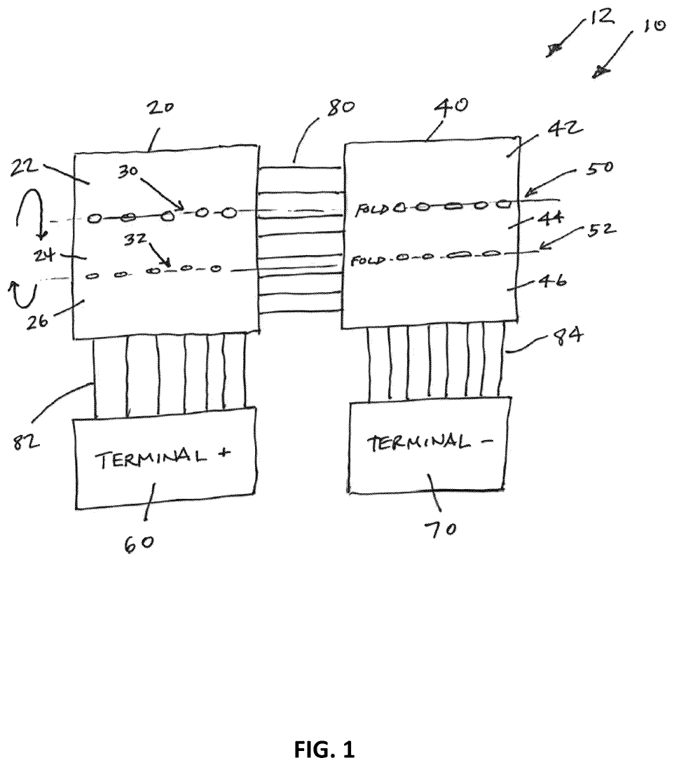

Referring to FIG. 1, a conductor 10 is shown in an unfolded configuration 12. The conductor 10 includes a conductor section or portion 20 with several conductor portions 22, 24, and 26 between which are fold lines 30 and 32 with perforations or cutouts, as shown. In addition, the conductor 10 includes a conductor section or portion 40 with several conductor portions 42, 44, and 46 between which are fold lines 50 and 52 with perforations or cutouts as well. Fuses 80 are located between conductor portions 20 and 40, fuses 82 are located between a positive terminal 60 and conductor portion 20, and fuses 84 are located between a negative terminal 70 and conductor portion 40.

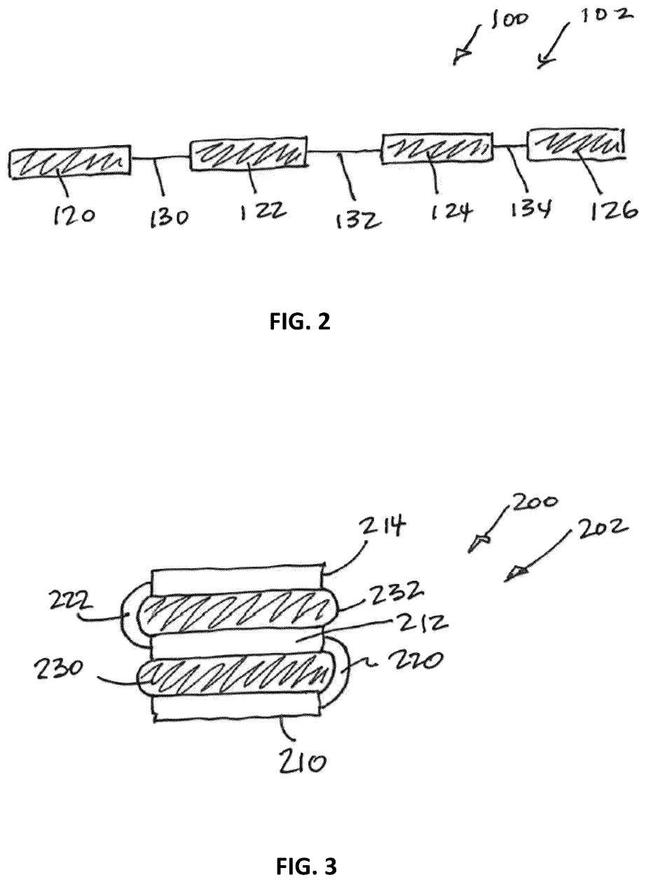

Turning to FIG. 2, another embodiment of a conductor 100 is illustrated in a folded configuration 102. The conductor 100 includes several conductor portions 120, 122, 124, and 126 which are connected by sets of fuses 130, 132, and 134 located between adjacent portions, as shown.

Referring to FIG. 3, another embodiment of a conductor 200 is illustrated in a folded configuration 202 forming a terminal. The conductor 200 includes conductor portions 210, 212, and 214 which have been folded relative to each other. Fuses 220 are located between portions 210 and 212, and fuses 222 are located between portions 212 and 214. In this embodiment, spark arresting material 230 is located between portions 210 and 212, and spark arresting material 232 is located between portions 212 and 214.

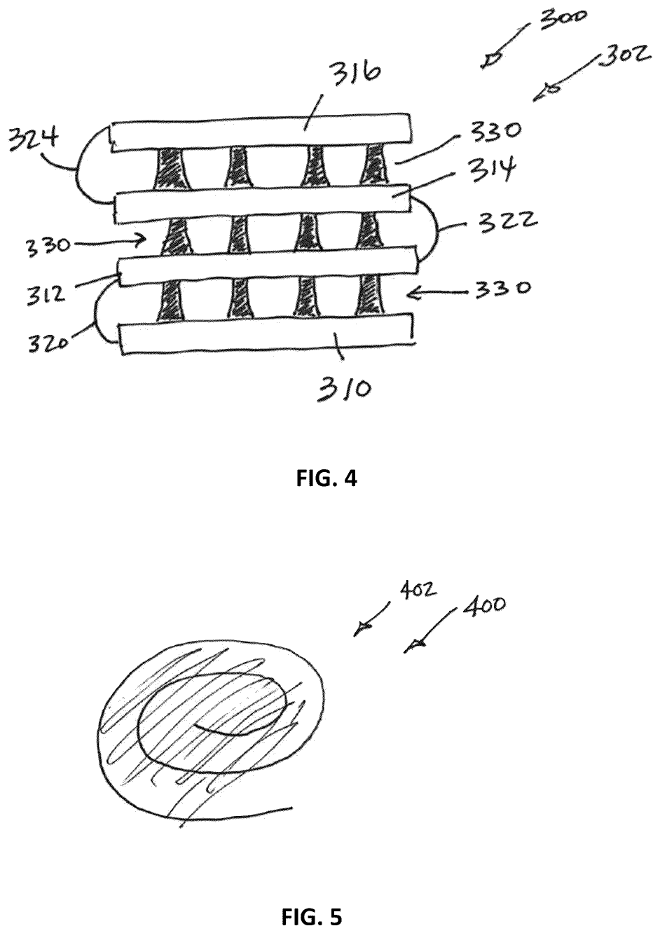

Referring to FIG. 4, another embodiment of a conductor 300 is illustrated in a folded configuration 302. The conductor 300 includes conductor portions 310, 312, 314, and 316 which have been folded relative to each other. Fuses 320 are located between portions 310 and 312, fuses 322 are located between portions 312 and 314, and fuses 324 are located between portions 314 and 316. In this embodiment, laser welding 330 is applied between each of the adjacent ones of the portions 310, 312, 314, and 316, as shown.

Referring to FIG. 5, a conductor 500 is shown with different conductor portions in a rolled configuration forming a terminal.

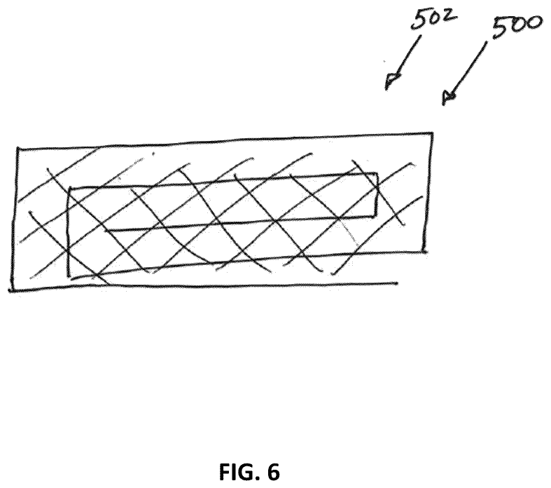

Referring to FIG. 6, a conductor 600 is shown with different conductor portions in a different folded configuration forming a terminal.

The technical solutions in the embodiments disclosed herein are described in detail below in combination with the drawings. Obviously, the described embodiments are only some of the possible embodiments, and are not all of them. Based on the embodiments of the present invention, all other embodiments obtained by ordinary technicians in this field without creative work are within the scope of protection of the present invention. In the description of the present invention, it should be noted that the terms “center,” “upper,” “lower,” “left,” “right,” “vertical,” “horizontal,” “inside,” “outside” and the like indicate the orientation or position relationship based on the orientation or position relationship shown in the drawings, which is only for the convenience of describing the present invention and simplifying the description, and does not indicate or imply that the device or element referred to must have a specific orientation, be constructed and operated in a specific orientation, and therefore cannot be understood as a limitation on the present invention.

In addition, the terms “first,” “second,” and “third” are only used for descriptive purposes and cannot be understood as indicating or implying relative importance. In this description, it should be noted that, unless otherwise clearly specified and limited, the terms “installation,” “connection” and “connecting” should be understood in a broad sense, for example, it can be a fixed connection, a detachable connection, or an integral connection; it can be a mechanical connection or an electrical connection; it can be a direct connection or an indirect connection through an intermediate medium, and it can be the internal connection of two components.

It should be noted that, in this article, the terms “include,” “comprises” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “including a . . . ” do not exclude the existence of other identical elements in the process, method, article or device including the elements. The above is only a specific implementation of the disclosed techniques. It should be pointed out that for ordinary technicians in this technical field, several improvements and modifications can be made without departing from the principles herein, and these improvements and modifications should also be regarded as part of the scope of protection herein.

What is claimed is:

1. A terminal, comprising:
a conductor including:
a first conductor section having:
a first conductor portion;
a second conductor portion;
a third conductor portion;
a first fold line located between the first conductor portion and the second conductor portion, the first fold line including a first plurality of cutouts; and
a second fold line located between the second conductor portion and the third conductor portion, the second fold line including a second plurality of cutouts.

2. The terminal of claim 1, wherein the conductor further comprises:
a second conductor section having:
a fourth conductor portion;
a fifth conductor portion;
a sixth conductor portion;
a third fold line located between the fourth conductor portion and the fifth conductor portion, the third fold line including a third plurality of cutouts; and
a fourth fold line located between the fifth conductor portion and the sixth conductor portion, the fourth fold line including a fourth plurality of cutouts.

3. The terminal of claim 2, wherein the conductor includes a first plurality of fuses located between the first conductor section and the second conductor section.

4. The terminal of claim 3, wherein the conductor includes a second plurality of fuses located between the first conductor section and a positive terminal.

5. The terminal of claim 4, wherein the conductor includes a third plurality of fuses located between the second conductor section and a negative terminal.

6. A terminal, comprising:
a conductor including:
a first conductor portion;
a second conductor portion;
a third conductor portion;
a first fuse being coupled to the first conductor portion and the second conductor portion;
a second fuse being coupled to the second conductor portion and the third conductor portion;
a first spark arresting material being located between the first conductor portion and the second conductor portion; and
a second spark arresting material being located between the second conductor portion and the third conductor portion, wherein the conductor is in a folded configuration.

7. The terminal of claim 6, wherein the conductor is in a stacked configuration.

8. The terminal of claim 6, wherein the conductor is in a rolled configuration.
